(19) United States
(12) Patent Application Publication
(10) Pub. No.: US 2013/0128760 A1
(43) Pub. Date: May 23, 2013

(54) DISTRIBUTED ANTENNA SYSTEM AND WIRELESS COMMUNICATION METHOD USED IN SAID SYSTEM

(71) Applicants: Kenzaburo Fujishima, Yokohama (JP); Tsuyoshi Tamaki, Machida (JP)

(72) Inventors: Kenzaburo Fujishima, Yokohama (JP); Tsuyoshi Tamaki, Machida (JP)

(73) Assignee: Hitachi, Ltd.

(21) Appl. No.: 13/812,043

(22) PCT Filed: Aug. 8, 2011
(86) PCT No.: PCT/JP2011/068088

§ 371 Date: Jan. 24, 2013

(30) Foreign Application Priority Data
Aug. 27, 2010 (JP) 2010-190254

(51) Int. Cl. H04W 72/04; H04W 24/10

(52) U.S. Cl. CPC H04W 72/04; H04W 24/10
USPC 370/252; 370/329

(57) ABSTRACT

A distributed antenna system that forms a plurality of communication areas and allows a plurality of terminals to communicate simultaneously, while minimizing variability in the quality of communication among the terminals. Said distributed antenna system: provides one or more logical antenna ports to wireless front-end units provided with remote radio heads (RRHs); forms a plurality of communication areas; determines the terminals that will communicate in each communication area; controls connection between the logical antenna port(s) and the front-end units per communication area; and uses signal-processing devices associated with the logical antenna ports to perform signal processing for each terminal.

### TECHNICAL FIELD

The present invention relates to a wireless communication system, or more particularly, to a distributed antenna system having antennas arranged in a decentralized manner.

### BACKGROUND ART

Cellular systems are requested to further improve a communication speed. A long-term evolution (LTE) system in which a maximum communication speed exceeds 100 Mbps is about to launch service.

The LTE system is characterized by a point that it introduces the orthogonal frequency-division multiple access (OFDMA) for a downlink access, and the single-carrier frequency-division multiple access (SCFDMA) for an uplink access. Both the schemes allow plural terminals to simultaneously gain access by decomposing a frequency domain into resource blocks and allocating the resource blocks to the separate terminals.

The LTE system is characterized by a point that frequency use efficiency is improved through multiple-input and multiple-output (MIMO). Further, the LTE system has a feature that the communications capacity on a wireless propagation path is further drawn out through closed-loop control between a base station and terminal. This is such that: the terminal estimates the state of the wireless propagation path; based on a result of the estimation, the terminal feeds a rank (rank indicator (RI)) of the wireless propagation path, a pre-coding matrix (pre-coding matrix indicator (PMI)) which the base station side should preferably employ, and communication quality (channel quality indicator (CQI)), based on which the base station side determines an optimal modulation method and code rate, back to the base station; and the base station side references the pieces of feedback information, and determines a data transmission method for the terminal.

In the LTE system, similarly in a conventional cellular system that employs the code division multiple access (CDMA) scheme, plural base stations share the same temporal frequency. In order to distinguish a base station which has transmitted a signal, production of a synchronizing (sync) signal with a cell ID inherent to a base station as a key, and scramble processing on a data signal are carried out. These LTE standards are disclosed in non-patent literature 1 and non-patent literature 2.

By the way, a distributed antenna system (DAS) is disclosed in patent literature 1 as a technology for suppressing a deviation of communication quality or a throughput due to a positional relationship between a transmitter and receiver.

In the patent literature 1, a technology is disclosed that allocates a resource to a wireless access unit which a user adopts according to a result of distance attenuation estimation which a central processing unit in a distributed antenna system performs on each of pieces of uplink information of the same user acquired from plural wireless access units.

Patent literature 2 discloses a technology allowing a remote node to communicate with plural antenna base stations, which are interconnected over a wired network, over different optical paths.

### CITATION LIST

### Patent Literature

Patent literature 1: Japanese Unexamined Patent Application Publication No. 2007-53768

Patent literature 2: Japanese Unexamined Patent Application Publication No. 2009-33226

### Non-patent Literature

Non-patent literature 1: “Evolved Universal Terrestrial Radio Access (E-UTRA); Physical Channels and Modulation (release 9, TS 36, 211, V9.0.0, 2009/12) by Third Generation Partnership Project (3GPP)

Non-patent literature 2: “Evolved Universal terrestrial Radio access (E-UTRA); Physical Layer Procedures (release 9, TS36, 213, V9.0.1, 2009/12) by 3GPP

### SUMMARY OF INVENTION

### Technical Problem

In the case of a distributed antenna system like the one described in the patent literature 1 or patent literature 2, although a SINR of a communication terminal can be raised, a throughput each terminal can enjoy owing to a decrease in the number of simultaneously communicating terminals diminishes in inverse proportion to the number of terminals belonging to a cell provided by a wireless access unit of the distributed antenna system. In other words, communication quality for each terminal largely varies depending on the disposition of the cell, and inter-terminal communication quality fluctuates.

The present invention is intended to provide a distributed antenna system which takes account of a fluctuation in inter-terminal communication quality, and in which plural communication areas are configured in order to allow plural terminals to simultaneously communicate.

### Solution to Problem

In order to solve at least one of the foregoing problems, one aspect of the present invention is a distributed antenna system having wireless front end units, and signal processing units associated with communication areas each configured with one or more wireless front end units. The distributed antenna system further includes a route control device that determines a configuration of plural communication areas, allocates terminals to determined communication areas, instructs the signal processing units to perform signal processing according to the allocation, and controls communications between the plural signal processing units and wireless front end units.

### Advantageous Effects of Invention

According to one aspect of the present invention, there is provided a distributed antenna system in which while a fluctuation in inter-terminal communication quality is suppressed, plural communication areas are configured in order to allow plural terminals to simultaneously communicate.

### BRIEF DESCRIPTION OF DRAWINGS

FIG. 1 is a diagram showing an example of a wireless communication system including a distributed antenna system;

FIG. 2 is a system configuration diagram of the distributed antenna system;

FIG. 3 is a diagram presenting types of signals to be treated in respective network devices;

FIG. 4 is a diagram showing an example of an RRH in a present embodiment;

FIG. 5 is a diagram showing an example of a route control device in the present embodiment;

FIG. 6 is a diagram showing an example of a centralized signal processing device in the present embodiment;

FIG. 7 is a functional block diagram of an MAC control unit;

FIG. 8 is a diagram showing an example of a cell multiple access control device in the present embodiment;

FIG. 9 is a diagram showing an example of an RRH preference list in the present embodiment;

FIG. 10 is a diagram showing an example of a cell configuration table in the present embodiment;

FIG. 11 is a diagram showing an example of an allocation list of cell configuration IDs and cell IDs to respective terminals in the present embodiment;

FIG. 12 is a flowchart for allocation of a configuration ID and cell ID to a terminal in accordance with the present embodiment;

FIG. 13 is a sequence diagram for initial access in an embodiment 1;

FIG. 14 is a sequence diagram in an example in which a cell configuration changes in the embodiment 1;

FIG. 15 is a sequence diagram in the example in which the cell configuration changes in the embodiment 1;

FIG. 16 is a sequence diagram for data communication in the embodiment 1;

FIG. 17 is a diagram showing a configuration in an embodiment 2 in which an area of one cell ID is divided into plural clusters;

FIG. 18 is an example of a method of allocating various channels to a temporal frequency resource for each cluster and each logical antenna port according to the embodiment 2;

FIG. 19 is a diagram showing an example of an RRH comparison device in the embodiment 2;

FIG. 20 is a diagram showing an example of a sequence for an intra-system handoff; and

FIG. 21 is a diagram showing an example of a sequence for an inter-system handoff.

### DESCRIPTION OF EMBODIMENTS

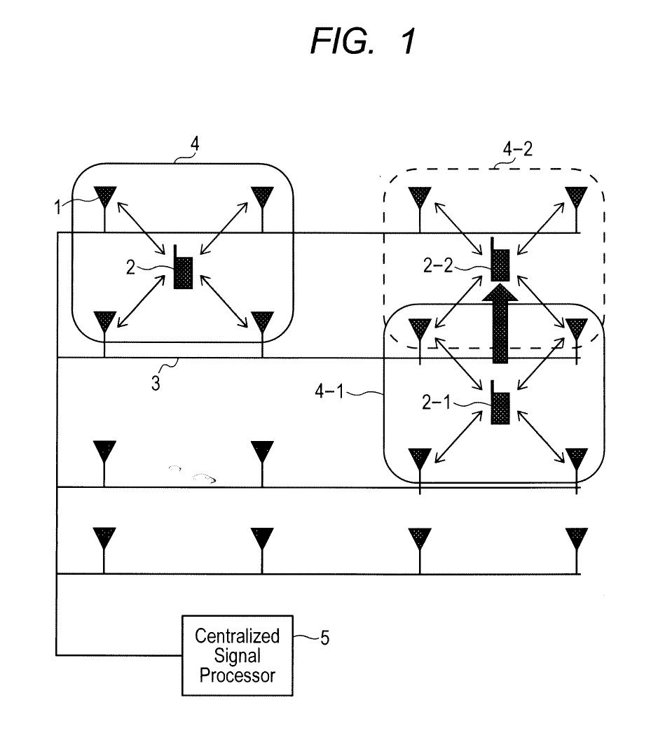

FIG. 1 shows an example of a wireless communication system including a distributed antenna system.

Antennas 1 are deployed on a planar basis in order to configure a distributed antenna system (DAS). The DAS uses the antennas 1 to perform wireless communication with one terminal or plural terminals 2. Each of the terminals 2 uses one antenna or plural antennas 1 to perform single-layer or multi-layer communication. Union of areas permitting communications through the antennas 1 provides a communication area for the entire DAS. The antennas 1 are connected to a centralized signal processing device 5 over optical fibers 3. An IQ sampling signal is transferred between each of the antennas 1 and the centralized signal processing device 5. The centralized signal processing device 5 performs signal processing simultaneously on the terminals 2, and realizes simultaneous communication of the plural terminals 2 at one temporal frequency.

A communication method desired by the terminals 2 is to perform communication using the antenna 1 whose distance to the terminal 2 is short. Accordingly, a receiving level of a desired signal improves, and a receiving level of a signal (interference signal for the terminal 2) concerning the antenna 1 through which any other terminal 2 communicates decreases. Therefore, improvement of a signal-to-interference plus noise ratio (SINR) concerning the desired signal is expected to improve. The principle for improvement of the SINR is to increase a difference between propagation losses on the desired signal and interference signal. In other words, the propagation loss (wireless propagation distance) on the desired signal is decreased, and the propagation loss (wireless propagation distance) on the interference signal is increased relatively to the desired signal.

In order to attain a high SINR for all the terminals 2, dynamic cell 4 formation intended to, as shown in FIG. 1, adapt a cell 4 to a terminal position is thought to be effective. However, when the shape of the cell 4 temporally varies, a wireless interface for a case where the cell shape dynamically varies is included.

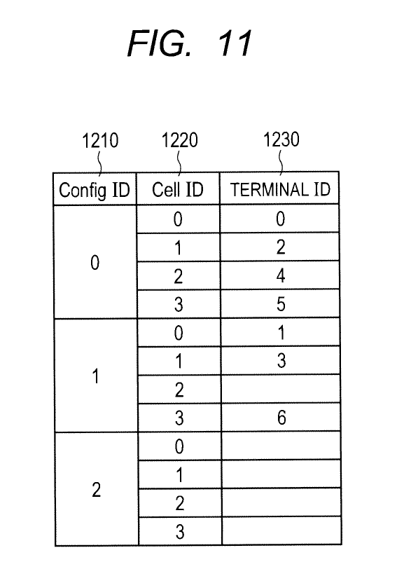

For example, as shown in FIG. 11, a case where since the terminal 2 moves from a position 2-1 to a position 2-2, a group of antennas 1 desirable to the terminal 2 changes will be discussed. In a conventional cellular system, since the shape of the cell 4 does not make a temporal change, inter-cell 4 handoff processing is carried out along with the movement of the terminal 2. However, in a cellular system in which dynamic cell formation is implemented, the cell 4 changes from a shape 4-1 to a shape 4-2 along with the movement of the terminal 2. This signifies that the cell ID of a signal to be treated by the antennas 1 changes according to the position of the terminal 2. The activity is not anticipated in the conventional cellular system.

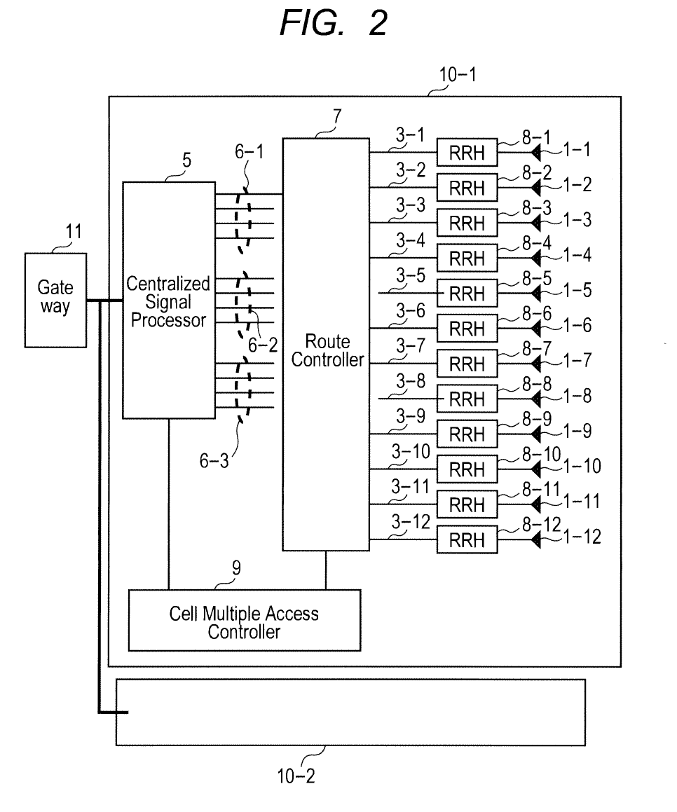

FIG. 2 is a system configuration diagram of a distributed antenna system 10.

Numerous antennas 1 are disposed on a planar basis, and a remote radio head (RRH) 8 is connected to each of the antennas 1. The RRHs 8 each include a wireless analog component that performs digital signal-to-analog signal conversion, baseband signal-to-radiofrequency band signal conversion, and amplification of an analog signal, and an optical signal-to-electrical signal converter serving as an interface to an optical fiber 3.

The optical fibers 3 link the RRHs 8 and a route control device (route controller) 7, and each bi-directionally transmit an IQ sampling signal, which is a digital baseband signal, as an optical signal.

The route control device 7 is a component that dynamically changes a cell shape, and is a control device that switches connections between logical antenna ports 6, which are an interface of the centralized signal processing device 5, and the RRHs, and changes the cell shape. A router control command is posted from a cell multiple access control device 9 to the route control device 7, and information necessary to control a router is posted to the cell multiple access control device 9. For signal transmission to the RRH 8 over the optical fiber 3, an optical signal is employed. However, since the logical antenna ports 6 treat an electrical signal, the route control device 7 includes an optical signal-to-electrical signal converter.

The logical antenna ports 6 are an input/output interface for a signal that is spatially multiplexed and transmitted. For connection between the centralized signal processing device 5 and route control device 7 which is the input/output interface, lead wires are employed. The logical antenna ports 6 are grouped in units of a cell (6-1 to 6-3). Plural logical antenna ports are included in each cell, and multi-layer communications (multiple-input and multiple-output (MIMO)) using the plural logical antenna ports is implemented in the cell.

The centralized signal processing device 5 communicates terminal user data (IP packet) to or from a gateway 11, and communicates an IQ sampling signal, which is a baseband digital signal, to or from the route control device 7 via the logical antenna port 6. Specifically, baseband signal processing of converting an IP packet into a baseband digital signal or vice versa is the major role of the centralized signal processing device 5. A result of selection of a communication terminal for each cell and a communication method (frequency, modulation scheme, code rate, or the like) are posted from the cell multiple access control device 9, and the centralized signal processing device 5 controls signal processing in each cell on the basis of the result of the posting.

The cell multiple access control device (cell multiple access controller) 9 is a device that controls multiple access of terminals in a system in which a dynamic cell is formed. More particularly, the cell multiple access control device determines a cell shape at a certain temporal frequency, determines a communication terminal in each cell and a communication method for each terminal (modulation scheme, code rate, or the like), posts route information between the logical antenna port 6 and RRH 8, which is based on the cell shape, to the route control device 7, and posts the result of the determination on the communication terminal and communication method to the centralized signal processing device 5. The cell multiple access control device 9 manages the groups of RRHs 8, which are desirable to respective terminals, and pieces of information on cells to which the respective terminals belong.

A body ranging from the antennas 1 to the centralized signal processing device 5 and cell multiple access control device 9 is a base station 10. Although the distributed antenna system described in conjunction with FIG. 2 includes numerous RRHs 8, the distributed antenna system is recognized as one base station 10-1 by the gateway 11. As for an entire wireless communication system, one gateway 11 accommodates numerous base stations (10-1, 10-2), manages to which of the base stations terminals belong, and performs routing control at the time of communicating an IP packet to the terminals.

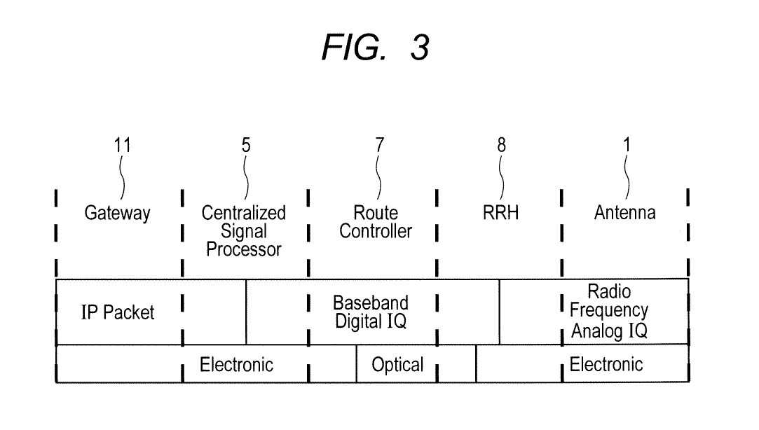

FIG. 3 presents types of signals to be treated by network devices.

The gateway 11 treats an IP packet with an electrical signal. The centralized signal processing device 5 treats the electrical signal as both an input and output, and performs conversion between an IP packet and a baseband digital IQ signal. The route control device 7 treats the baseband digital IQ signal as both the input and output. However, since the RRHs 8 side treats an optical signal, the route control device 7 internally performs optical-to-electrical conversion. The RRHs 8 connected to the route control device 7 over optical fibers perform optical-to-electrical conversion through an interface on the route control device 7 side. Further, for transferring a radiofrequency band analog signal to or from the antennas side, the RRHs 8 side performs baseband-to-radiofrequency band conversion and digital-to-analog conversion. The antennas 1 treat the electrical signal of the radiofrequency band analog signal.

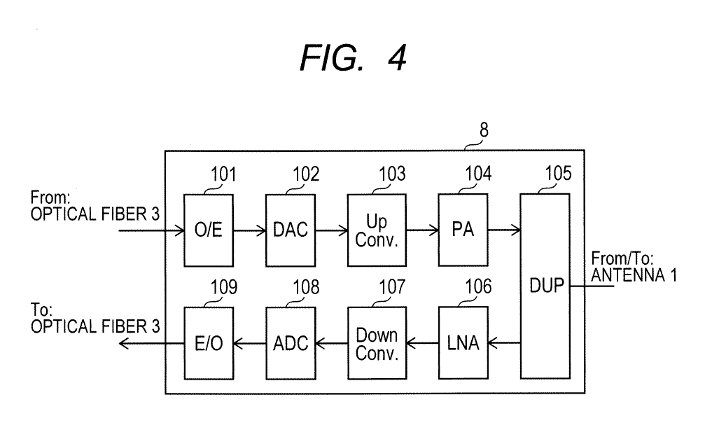

FIG. 4 shows an example of the RRH 8 in the present embodiment.

The RRH 8 performs optical signal-to-electrical signal conversion, digital-to-analog conversion, and baseband-to-analog conversion on a signal transferred between the antenna 1 and route control device 7. An optical signal inputted from the route control device 7 over the optical fiber 3 is converted into an electrical signal by an optical-to-electrical converter 101, and converted from a baseband digital signal to a baseband analog signal by a digital-to-analog converter 102. The baseband analog signal is converted into a radiofrequency band analog signal by an upconverter 103, amplified by a power amplifier 104, and outputted to the antenna 1 via a duplexer 105.

A radiofrequency band analog signal that is a terminal transmission signal received by the antenna 1 is passed through the duplexer 105, amplified by a low-noise amplifier 106, converted into a baseband analog signal by a downconverter 107, and further converted into a baseband digital signal by an analog-to-digital converter 108. Thereafter, the baseband digital signal that is an electrical signal is converted into an optical signal by an electrical-to-optical converter 109, and outputted to the route control device 7 over the optical fiber 3.

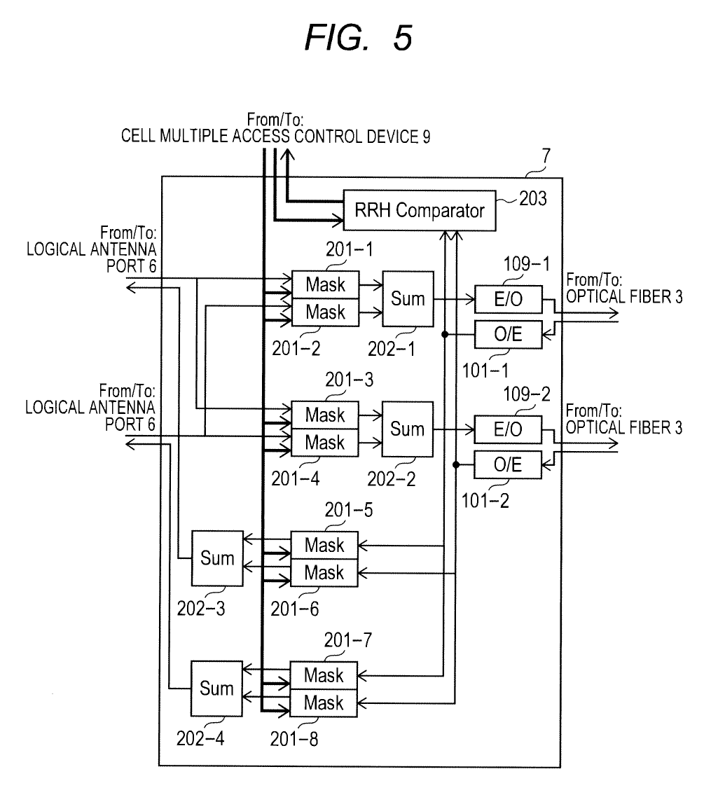

FIG. 5 shows an example of the configuration of the route control device in the present embodiment.

The left side is an interface to the logical antenna ports 6, and the right side is an interface to the optical fibers 3. The optical-to-electrical converter 101 and electrical-to-optical converter 109 are included on the optical fibers 3 side.

On receipt of an instruction from the cell multiple access control device 9, mask units 201 control whether an inputted electrical signal is passed through or zero is outputted. The mask units 201 are logical circuits that perform AND processing on a bit level. For passing through an input signal, AND processing of bits of all 1s is carried out. For outputting zero, AND processing of bits of all 0s is carried out.

Summation units 202 are logical circuits that simply summate the outputs of the plural mask units 201. Route control between the logical antenna ports 6 and RRHs 8 is implemented by setting bit mask in the mask units 201.

An RRH comparison unit 203 inputs uplink baseband digital signals that are converted into electrical signals by the optical-to-electrical converters 101 in all the RRHs 8 and received from a terminal over the optical fibers 3, and measures the receiving levels of a transmitting signal, which is sent from a terminal, at the respective RRHs 8 through matched filter processing performed on the receiving signals by the RRHs 8. The RRH comparison unit 203 compares the results of the measurement among the RRHs, selects higher-rank RRHs, and specifies one or plural RRHs which the terminal should use. The RRH comparison unit 203 calls the specified RRHs a RRH preference list for each terminal, and posts it to the cell multiple access control device 9. On the other hand, information inherent to a terminal, a time frame, and other information which are needed to produce a standby pattern to be set in a matched filter, is posted from the cell multiple access control device 9 to the RRH comparison unit 203. Based on the posted information, the RRH comparison unit 203 produces a standby pattern for the matched filter, and performs correlation arithmetic with respect to an input signal.

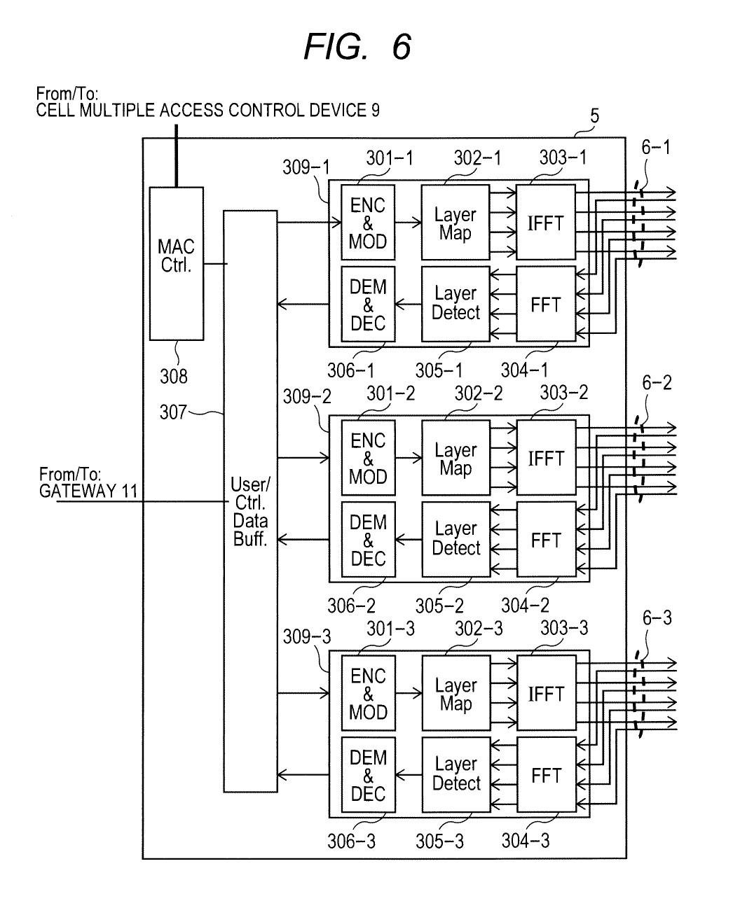

FIG. 6 shows an example of the centralized signal processing device in the present embodiment. The centralized signal processing device 5 includes plural cell individual signal processing units 309-1, 309-2, and 309-3, a user/control data buffer 307, and a MAC control unit 308.

The cell individual signal processing unit includes modules described below.

Terminal user data inputted from the gateway 11, and control data produced by the MAC control unit 308 are tentatively stored in the user/control data buffer 307, and has a bit string converted into an IQ symbol string by an encoding and modulation module 301.

The encoding and modulation module 301 inputs a mass of bit strings called a transport block. The encoding and modulation module 301 performs separation of the transport block into code words, convolution encoding for each code word, rate matching, and modulation symbol production processing such as QPSK or 64QAM. An output of the encoding and modulation module 301 is a modulated symbol string of each code word. The size of the transport block, the number of times of repetition to be performed during rate matching for each code word, and a modulation scheme are determined according to a result of posting from the cell multiple access control device 9.

A layer map module 302 maps a code word, which is a data signal or control signal, into a spatial layer, subcarrier, and OFDM symbol, and performs pre-coding processing. In addition, the layer map module 302 performs production of a pilot symbol and sync symbol and mapping. An output of the layer map module 302 is a frequency-domain symbol string for each logical antenna port 6.

An IFFT module 303 performs inverse Fourier transform processing on a frequency-domain symbol string of each OFDM symbol for each logical antenna port, and outputs a time-domain IQ sampling signal. N last-half samples of the time-domain IQ sampling signal are appended as a cyclic prefix (CP) to the leading edge of the sampling signal. The IQ sampling signal having the CP appended thereto is treated as an output to the logical antenna port 6, and inputted to the route control device 7.

An FFT module 304 inputs a receiving baseband digital IQ sampling signal, which is sent from a terminal and inputted from the route control device 7, with the CP appended thereto, discards samples equivalent to the length of the CP, performs Fourier transform processing on each OFDM (or SCFDM) symbol, and outputs a frequency-domain symbol string. At the time of outputting, a portion other than a valid subcarrier is discarded.

A layer detection module 305 uses an uplink demodulation pilot signal to perform propagation path estimation. After changing the results of channel estimation for the plural logical antenna ports into a matrix, the layer detection module 305 produces a receiving weight matrix according to, for example, the rule of minimum mean square error (MMSE), multiplies vectors of frequency-domain receiving symbols at the plural logical antenna ports by the weight matrix, and thus obtains symbol strings that are separated layer by layer for each subcarrier and each OFDM (SCFDM) symbol. The symbol strings are rearranged in units of a code word, and outputted.

A demodulation and decoding module 306 first performs soft decision on receiving symbol strings, which are arranged in units of a code word, so as to calculate logarithmic (log) likelihood ratios for respective bits. The log likelihood ratios are repeatedly updated through a turbo decoder. Finally, hard decision is performed, and bit strings for respective cord words are outputted to the user/control data buffer 307, and thus stored in a memory.

The foregoing set of the encoding and modulation module 301, layer map module 302, IFFT module 303, FFT module 304, layer detection module 305, and demodulation and decoding module 306 is the components of the cell individual signal processing unit 309. Each of the cell individual signal processing units 309 provides a terminal with one cell. The cell individual signal processing units 309-2 and 309-3 have the same components.

The user/control data buffer 307 is a memory. A transmitting data signal for a terminal is stored by the gateway 11, and a transmitting data signal from the terminal is stored by each of the cell individual signal processing units 309. A control signal concerning the transmitting data signal for the terminal is stored by the MAC control unit 308, and a control signal concerning the transmitting data signal from the terminal is stored by each of the cell individual signal processing units 309, and referenced by the MAC control unit 308.

In order to allow each of the cell individual signal processing units 309 to read a transmitting data signal for a terminal, the MAC control unit 308 stores in a memory control information concerning data communication addressed to each of the cell individual signal processing units 309. Thereafter, each of the cell individual signal processing units 309 references the stored control information so as to acquire an addressee terminal of data communication and a communication method (transport block size, modulation scheme, allocated spatial frequency resource, pre-coding matrix, etc.). Based on the result of the acquisition, the cell individual signal processing unit 309 reads data of the transport block size from the data buffer of the designated terminal, and produces a data channel. In addition, the cell individual signal processing unit 309 acquires the communication method as control information for the data, and produces a control channel.

By the way, as for writing of a transmitting data signal sent from a terminal from each of the cell individual signal processing units 309, bit strings that have been successfully decoded are sequentially written. However, in order to implement receiving signal processing in each of the cell individual signal processing units 309, it is necessary to learn in what communication method a data signal sent from what terminal is communicated at what spatial frequency resource. Therefore, the MAC control unit 308 stores the pieces of information in the user/control data buffer 307 as information representing a receiving method, and each of the cell individual signal processing units 309 reads the information.

Pieces of control information sent from a terminal (ACK/NACK for a downlink data signal, or feedback information such as a CQI, RI, or PMI) are stored in the user/control data buffer 307 in the order in which they are successfully decoded. The MAC control unit 308 acquires the pieces of stored information, and performs production of control information for downlink communication at a time succeeding the time of acquisition, or termination processing concerning downlink data communication (discarding user data stored in the memory).

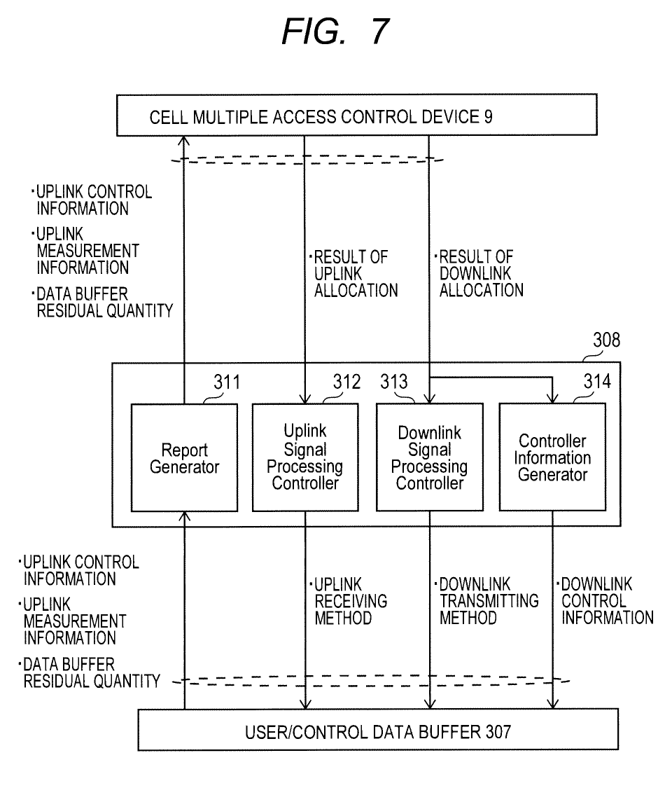

The MAC control unit 308 is, for example, a processor. The MAC control unit 308 performs (1) posting of a data signal volume to be processed by each of the cell individual signal processing units 309 during downlink communication, an addressee terminal, and a communication method, (2) production of a transfer bit string on a control channel concerning (1), (3) posting of a data signal volume on which each of the cell individual signal processing units 308 performs receiving processing during uplink communication, a transmission source terminal, and a communication method, (4) acquisition of control information sent from a terminal (ACK/NACK and CQI, RI, or PMI), (5) acquisition of packet scheduling information from the cell multiple access control device 9, and (6) positing of the feedback information (4) to the cell multiple access control device 9. FIG. 7 shows a detailed example.

FIG. 7 shows an example concerning a functional block diagram of the MAC control unit.

The MAC control unit 308 includes a report generator 311 that provides the cell multiple access control device 9 with information needed to make a decision, an uplink signal processing controller 312 that posts a receiving method adopted by each of the cell individual signal processing units 309 via the user/control data buffer 307 on receipt of the posted result of scheduling of uplink packets from the cell multiple access control device 9, a downlink signal processing controller 313 that posts a transmitting method adopted at each of the cell individual signal processing units 309 via the user/control data buffer 307 on receipt of the posted result of scheduling of downlink packets from the cell multiple access control device 9, and a downlink control information generator 315 that produces an individual control signal to be transmitted to each terminal on the basis of the result of downlink packet scheduling posted from the cell multiple access control device 9.

The report generator 311 summarizes pieces of information, which are necessary for the cell multiple access control device 9 to perform packet scheduling, as a report, and posts the report to the cell multiple access control device 9. The pieces of necessary information fall broadly into information necessary to perform downlink packet scheduling and information necessary to perform uplink packet scheduling.

The former encompasses a desirable communication method measured at a terminal (CQI, RI, PMI), uplink control information including ACK/NAK relevant to downlink data communication, and a downlink data queue residual quantity for each terminal. The CQI, RI, PMI, and ACK/NAK are contained in an uplink control channel, and written in the user/control data buffer 307 by each of the cell individual signal processing units 309. The written data items are therefore referenced. The downlink data queue residual quantity for each terminal can be acquired by monitoring a data residual quantity for each terminal which the report generator 311 itself has recorded in the user/control data buffer 307.

The latter encompasses a desirable communication method (CQI, RI, PMI) for each terminal measured by the cell individual signal processing unit 309, ACK/NAK relevant to uplink data communication, and a transmitting data buffer residual quantity to be posted from the terminal. The CQI, RI, and PMI can be acquired when the report generator 311 references a result of measurement, which is performed by each of the cell individual signal processing units 309, written into the user/control data buffer 307. The ACK/NAK can be acquired when the report generator 311 references a result of decoding, which is performed by each of the cell individual signal processing units 309, written into the user/control data buffer 307. The transmitting data buffer residual quantity is contained in an uplink control channel. Therefore, the transmitting data buffer residual quantity can be acquired when the report generator 311 references a result of decoding of a control channel, which is performed by each of the cell individual signal processing units 309, written into the user/control data buffer 307.

The uplink signal controller 312 fills the role of a physical layer driver that posts a receiving method to each of the cell individual signal processing units 309 on the basis of the result of uplink packet scheduling posted from the cell multiple access control device 9 (transmitting source terminal, frequency-space resource, pre-coding matrix, modulation scheme, rank, etc.).

The downlink signal processing controller 313 fills, similarly to the uplink signal processing controller 312, the role of a physical driver that posts a transmitting method to each of the cell individual signal processing units 309 on the basis of the result of downlink packet scheduling posted from the cell multiple access control device 9 (transmitting source terminal, frequency-space resource, pre-coding matrix, modulation scheme, rank, etc.).

The downlink control information generator 314 produces as an MAC message a transmitting method, which each addressee terminal requires to receive data, (frequency-space resource, pre-coding matrix, modulation scheme, rank, etc.), on the basis of a result of downlink packet scheduling posted from the cell multiple access control device 9, and allows each of the cell individual signal processing units 309 to produce a control channel (for example, physical dedicated control channel (PDCCH)) via the user/control data buffer 307.

The foregoing report generator 311, uplink signal processing controller 312, downlink signal processing controller 313, and downlink control information generator 314 may be included in the cell multiple access control device 9. In this case, the cell multiple access control device 9 fills the role of a physical layer driver for each of the cell individual signal processing units 309.

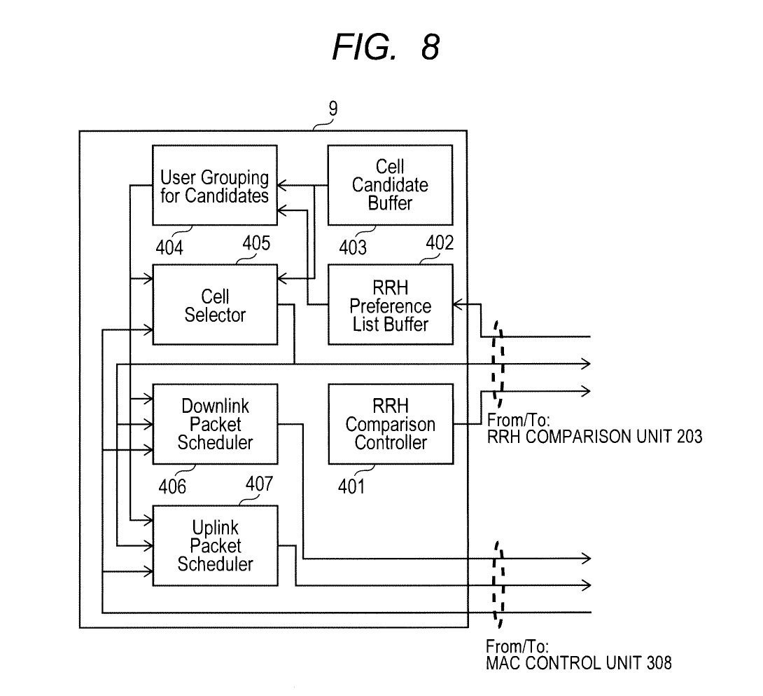

FIG. 8 shows an example of the cell multiple access control device in the present embodiment.

The cell multiple access control device 9 is a processor and memory that has an interface to each of the RRH comparison unit 203 and MAC control unit 308.

An RRH comparison control unit (RRH comparison controller) 401 posts a terminal ID and information, which is necessary to produce a standby pattern for correlation arithmetic, such as a sub-frame number, to the RRH comparison unit 203. After a result is written in an RRH comparison result buffer (RRH preference list buffer) 402, information such as a terminal ID relevant to the next terminal is written.

The RRH comparison result buffer (RRH preference list buffer) 402 is a buffer in which a result of RRH selection, which is performed based on the best M receiving powers (M denotes an integer, for example, 4) of an uplink signal, is recorded for each terminal together with a terminal number. The RRH comparison result buffer 402 records an RRH preference list for each terminal which is a result of comparison.

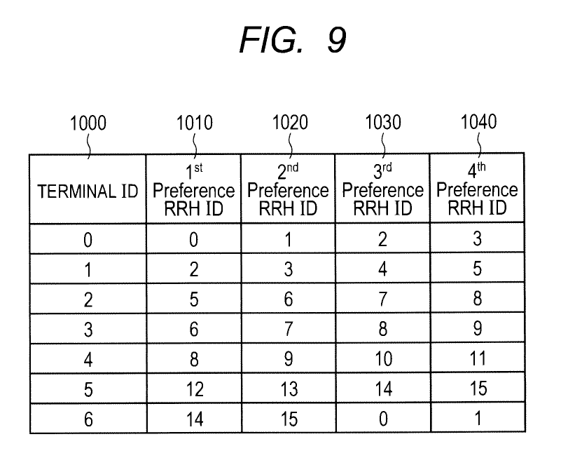

FIG. 9 shows an example of an RRH preference list stored in the RRH comparison result buffer 402. A result posted from the RRH comparison unit 203 is information containing a set of a terminal ID 1000, and the best M RRH individual identification numbers (RRH identifier) (M equals 4 in FIG. 9) 1010, 1020, 1030, and 1040 of RRHs at which an uplink signal from the terminal is received strongly, and is recorded in the RRH comparison result buffer 402 in a format shown in FIG. 9.

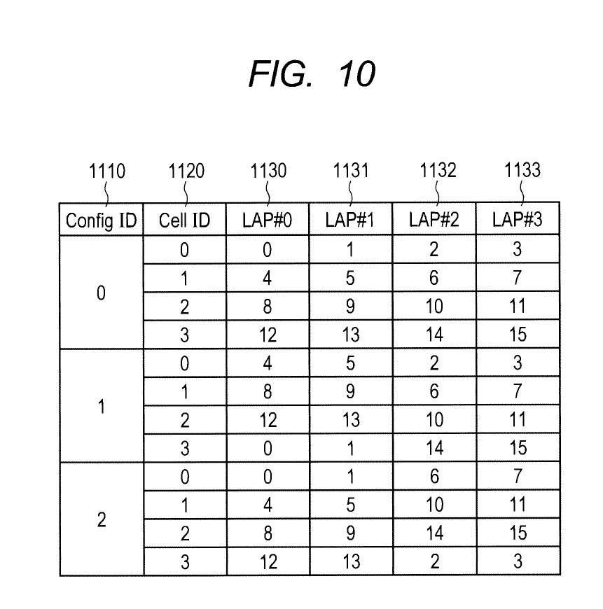

Referring back to FIG. 8, a cell candidate buffer 403 records a preset table, which is preset in a flash ROM or the like, in the format like the one shown in FIG. 10. A configuration ID is an ID of a set of cells. In FIG. 10, plural sets are stored. To what RRHs logical antenna ports for each cell are connected varies among configuration IDs. In short, the shape of each cell is varied by switching the configuration IDs using FIG. 10.

A user grouping unit (user grouping for candidates) 404 references the RRH preference list shown in FIG. 9 and the cell configuration table shown in FIG. 10 so as to allocate an optimal configuration ID and cell ID to each terminal. When the RRH preference list of FIG. 9 is inputted, if the configuration table of FIG. 10 is conformed, terminals are allocated the configuration IDs and cell IDs shown in FIG. 11. Basically, a configuration ID and a set of cell IDs making the largest number of RRH individual identification numbers, which are used by a terminal, consistent with the RRH individual identification numbers desirable to terminals recorded in the RRH preference list are allocated to the terminal.

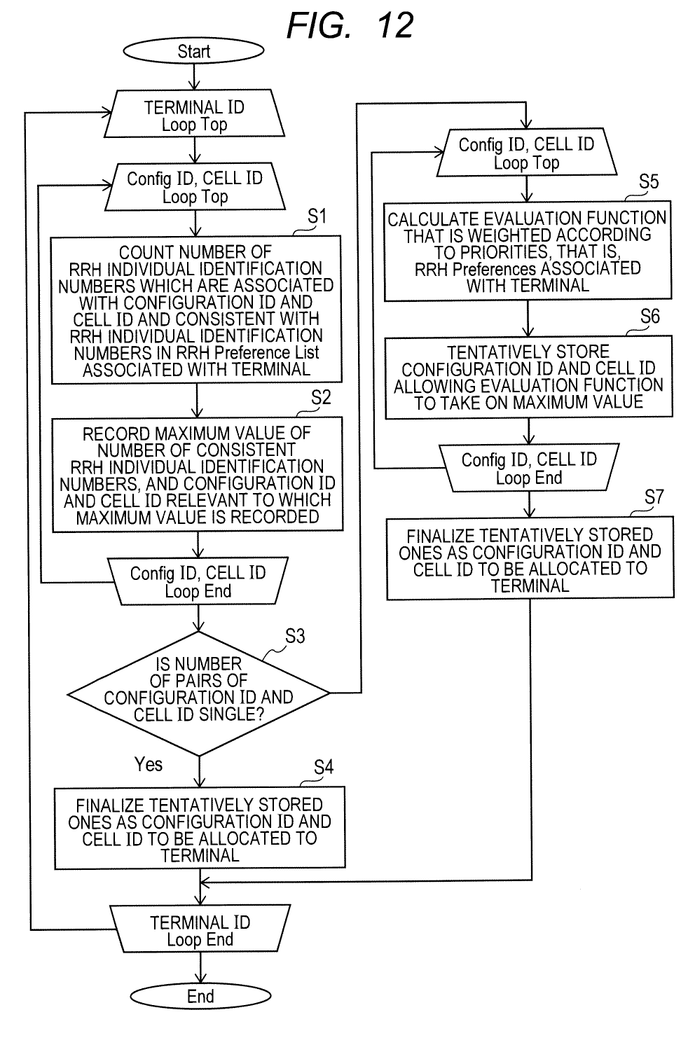

FIG. 12 is a flowchart for allocating a configuration ID and cell ID to a terminal.

An object of the flowchart is to finalize a configuration ID and cell ID for each terminal ID. As step S1, the user grouping unit 404 counts the number of RRH individual identification numbers (FIG. 9) 1010, 1020, 1030, and 1040 relevant to a terminal ID 1000 which are consistent with RRH individual identification numbers (1130, 1131, 1132, and 1133 in FIG. 10) connected to logical antennas LPA which are associated with a configuration ID 1110 and cell ID 1120. At step S2, a pair of a configuration ID and cell ID maximizing the number of consistent RRH individual identification numbers are tentatively recorded. Plural pairs may be recorded. Step S1 and step S2 are repeated with respect to all configuration IDs and cell IDs. At step S3, whether the number of tentatively recorded pairs of the configuration ID and cell ID is one or not is decided. If the number of recorded pairs is one, processing proceeds to step S4. The pair of the configuration ID and cell ID tentatively recorded at step S2 is allocated to the terminal. If plural pairs are tentatively recorded, processing shifts to activities for selecting a single pair of the configuration ID and cell ID described in the flow on the right side of the flowchart.

At step S5 and step S6, the user grouping unit 404 performs loop activities on plural pairs of a configuration ID and cell ID tentatively recorded at step S2. At step S5, since RRH IDs are recorded with priorities given thereto in the RRH preference list of FIG. 9 in such a manner as the first preference RRH ID or second preference RRH ID, if, for example, the first preference of the terminal ID is included in association with the pairs of the configuration ID and cell ID, a score 4 is provided. If the first preference is not included, a score 0 is provided. Likewise, if the second preference of the terminal ID is included, a score 3 is provided. If the third preference is included, a score 2 is provided. Thus, an evaluation function value being weighted according to a priority, that is, an RRH preference is obtained. At step S6, the user grouping unit 404 tentatively records the Pair of configuration ID and cell ID causing the evaluation function at step S5 to take on a maximum value. On a stage where loop processing concerning the pair of the configuration ID and cell ID is completed, the user grouping unit 404 allocates the pair of the configuration ID and cell ID, which is tentatively recorded at step 87, to the terminal. Assuming that plural pairs of the configuration ID and plural cell ID are tentatively recorded, any of the pairs may be selected.

Through the activities presented in FIG. 12, an allocation list of configuration IDs 1210 and cell IDs 1220 to terminals (terminal IDs 1230) shown in FIG. 11 is completed based on FIG. 9 and FIG. 10.

Referring back to FIG. 8, a cell selection unit 405 (cell selector) determines a configuration ID, which indicates a set of cells of a distributed antenna system on the basis of the allocation list of configuration IDs and cell IDs shown in FIG. 11. The simplest determination method is round robin among the configuration IDs. However, the configuration ID to which no terminal belongs is skipped. Based on a result of determination of the configuration ID, the relationship of connection (FIG. 10) between logical antenna ports specified in association with the configuration ID and RRHs is posted from the cell candidate buffer 403 to the RRH comparison unit 203.

The cell selection unit 405 posts the determined configuration ID to a downlink packet scheduler 406 and uplink packet scheduler 407. For determining the configuration ID, a CQI inputted from the MAC control unit 308 may be referenced to determine the configuration ID according to a proportional fairness rule. At this time, a denominator of an evaluation function for proportional fairness is a mean throughput of all terminals belonging to the configuration ID, and a numerator is an expectation value of an instantaneous throughput of all the terminals belonging to the configuration ID.

The downlink packet scheduler 406 and uplink packet scheduler 407 are packet schedulers having the configuration ID, which is determined by the cell selection unit (cell selector) 405, as a restriction. Namely, a terminal that does not belong to the configuration ID is not subjected to packet scheduling. The terminals belonging to the configuration ID become apparent by referencing the allocation list (FIG. 11) of configuration IDs and cell IDs which is produced by the user grouping unit (user grouping for candidates) 404. Packet scheduling for each cell ID is an activity identical to that in a conventional cellular system.

The results of resource allocation by the downlink packet scheduler 406 and uplink packet scheduler 407 are posted to the MAC control unit 308 and used to control transmitting/receiving activities.

An example in which the distributed antenna system configures plural cells has been described so far. Hereinafter, using a concrete example, a description will be made of a case where a cell configuration is modified for a terminal which operates in a system described in the non-patent literature 1 or 2. The concrete example provides a transparent system that is unconscious of the fact that the cell configuration is modified by the distributed antenna system.

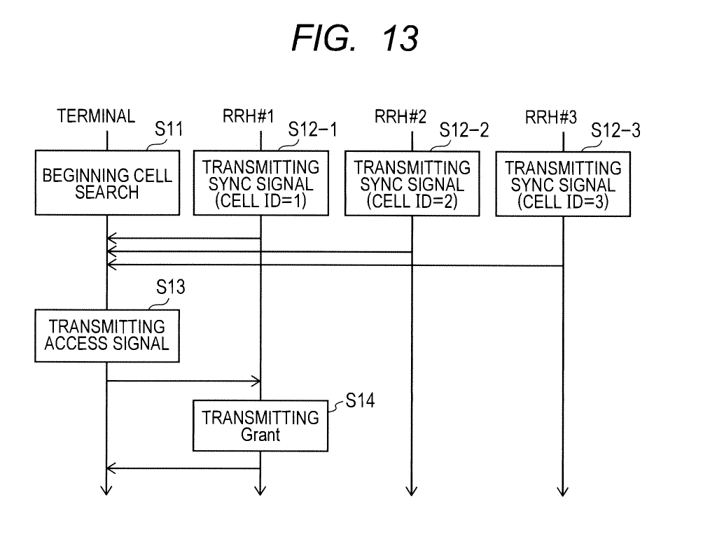

FIG. 13 is a sequence diagram for an initial access. Assume that numerous RRHs are arranged in a decentralized manner as a distributed antenna system, and the RRHs receive or transmit cell ID signals shown in the drawing. A terminal begins a cell search activity so as to catch a sync signal sent from a network side (distributed antenna system) (S11). The network side transmits the cell ID sync signals shown in the drawing from the respective RRHs (S12-1, S12-2, S12-3). The terminal receives the sync signals, measures a receiving power relevant to each cell ID, and transmits an access signal to the cell ID relevant to the largest receiving Power (S13). The network having received the access signal transmits Grant which signifies that the terminal is acknowledged to access the network (S14). Through the activities, the terminal is wirelessly connected to the network, and begins data communication after requesting a service and being authenticated.

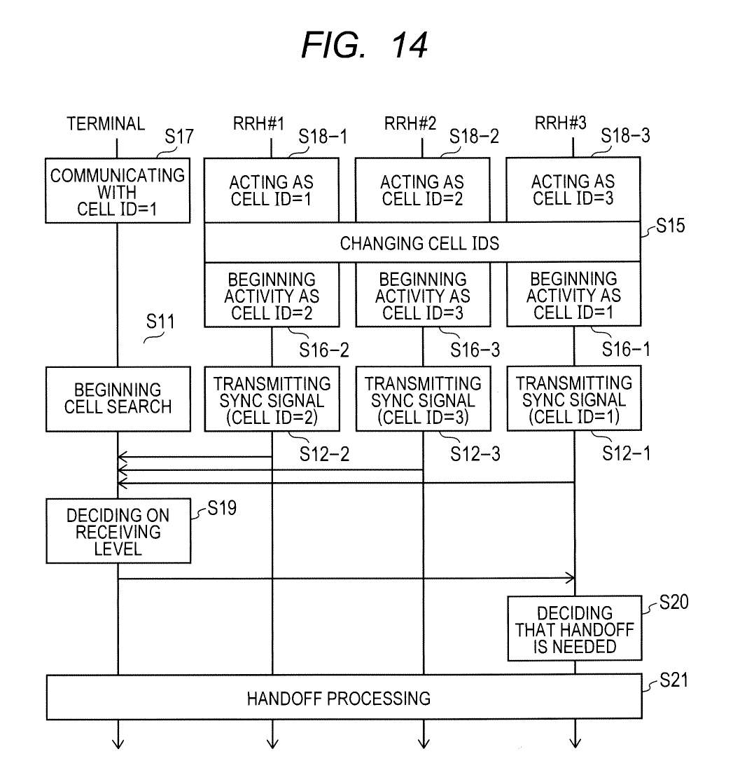

FIG. 14 is a sequence diagram in a wireless communication system, in which a cell configuration varies, in accordance with the embodiment 1.

In an initial state in FIG. 14, a terminal is performing communication in a cell of a cell ID=1, and RRHs fill the role of transmitting or receiving cell ID signals shown in the drawing. During the activities, if the cell IDs of cells which the RRHs are in charge of are modified (S15), the terminal measures receiving powers of a sync signal relevant to the respective cell IDs through cell search which is periodically carried out (S19). The terminal receives the sync signal of the cell ID=2, which is transmitted from the RRH #1 located most closely to the terminal, with the strongest power. The results of the measurement are transmitted from the terminal to the network. The receiving power in the cell of the cell ID=1 to which the terminal has been connected is compared with the receiving power in the cell of the cell ID=2 in which the largest receiving power is observed this time. The network side decides that a handoff is needed (S20), and handoff processing (S21) is begun at the terminal and on the network side.

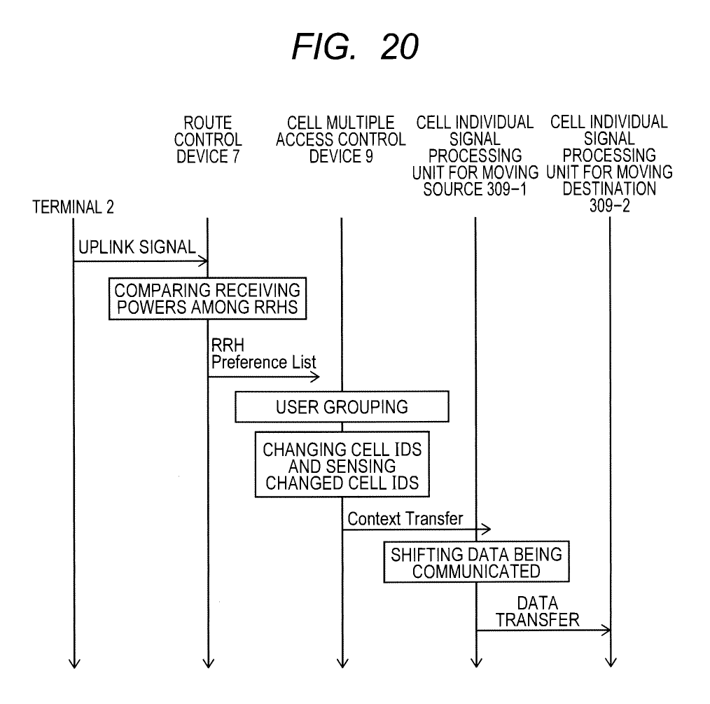

FIG. 20 is a sequence diagram presenting handoff activities in a distributed antenna system so as to describe concrete processing of S21.

The route control device 7 measures receiving powers of an uplink signal from a terminal, and posts an RRH preference list, which is based on a result of comparison among RRHs, to the cell multiple access control device 9. In the cell multiple access control device 9, the user grouping unit (user grouping for candidates) 404 determines a configuration ID and cell ID for the terminal as it usually does. After the determination is made, if the cell ID is changed from one to another, a handoff is executed.

When a handoff is executed, the cell multiple access control device 9 changes an entity, which performs signal processing for the terminal, from the cell individual signal processing unit 309-1 for a moving source to the cell individual signal processing unit 309-2 for a moving destination. If data being communication remains in the cell individual signal processing unit 309-1 for the moving source, the data being communicated is dislocated to the cell individual signal processing unit 309-2 for the moving destination.

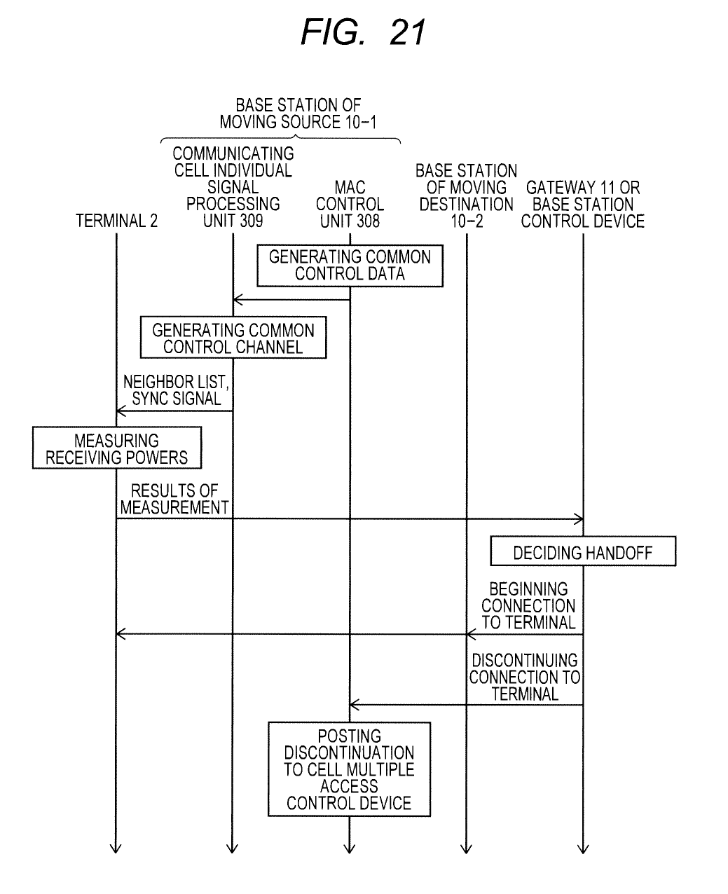

FIG. 21 is a sequence diagram presenting a handoff activity from the distributed antenna system 10-1 to another distributed antenna system or a base station 10-2.

Basic activities are conformable to those of the LTE system described in the non-patent literature 1 or 2. To begin with, the MAC control unit 305 in a moving source base station 10-1 inputs a neighbor list, which presents cell IDs of base stations located in the neighborhood of the moving source base station 10-1 that organizes the distributed antenna system, to all the cell individual signal processing units 309 as common control information of the entire moving source base station 10-1. The cell individual signal processing units 309 each embed the information on a common control channel, and the information is thus broadcasted to terminals within the moving source base station 10-1. A terminal measures the receiving power of a downlink signal from the moving source base station 10-1 and the receiving powers of downlink signals from the neighbor base stations specified in the neighbor list, and feeds back the results of the measurement to the gateway 11 or a base station control device that organizes plural base stations. The gateway 1 or base station control device references the fed back results so as to compare the results of measurement of the receiving powers from the base stations with one another, and decides whether a handover should be carried out. If it is decided that a handover should be carried out, the moving destination base station 10-2 is allowed to establish a connected to the terminal. After the establishment of the connection is verified, the MAC control unit 308 of the moving source base station 10-1 is instructed to discontinue the connection to the terminal. The MAC control unit 308 having received a connection discontinuation command notifies the cell multiple access control unit 309 of the fact that the terminal has discontinued the connection. The cell multiple access control unit 309 deletes allocation information such as the RRH preference list of FIG. 9 and configuration ID of FIG. 11 relevant to the terminal.

The first embodiment has been described so far.

According to the foregoing embodiment, in a distributed antenna system, wireless front end units whose communication states relevant to a terminal are satisfactory are used to dynamically configure a cell. Accordingly, for example, place dependency of communication quality of the terminal can be reduced. If plural cells are dynamically configured, for example, plural simultaneously communicating terminals can be ensured, and a throughput each terminal can enjoy can be improved.

If a configuration that is a combination of plural communication areas is prepared in advance and selectively utilized, loads on processors used to define the communication areas can be decreased.

If signal processing and packet scheduling are performed based on a wireless propagation path between a wireless front end unit and a terminal in each cell, a communication capacity of a wireless communication path can be effectively utilized. As a result, a throughput the terminal can enjoy can be improved.

Next, the second embodiment will be described below. As for the second embodiment, a description will be made by taking for instance a case where the distributed antenna system in the first embodiment is used to provide a terminal with a communication area. Unless otherwise noted, a configuration or processing is identical to that in the first embodiment.

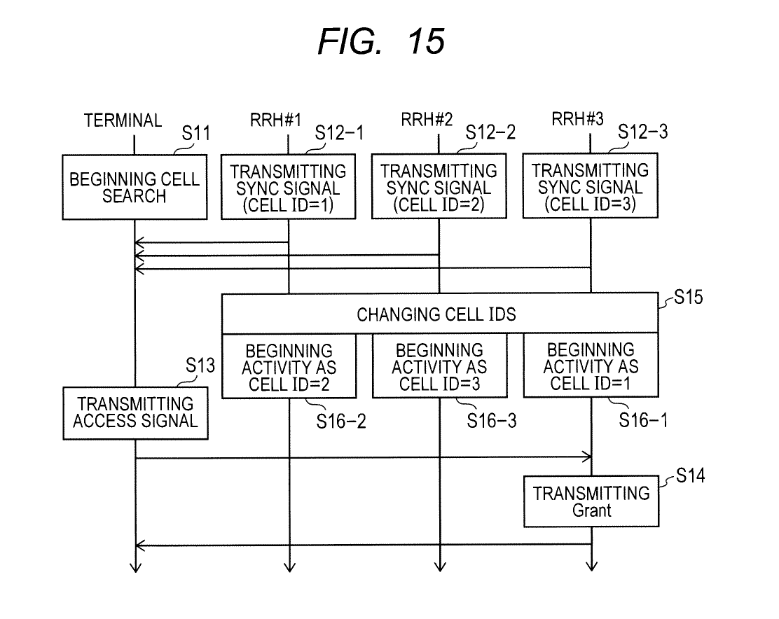

Referring to FIG. 15, a description will be made of a case where the distributed antenna system in the first embodiment configures plural cells as mentioned in FIG. 13, and then modifies the configuration.

In FIG. 15, after a cell search activity (S11) by a terminal and sync signal transmission (S12-1, S12-2, S12-3) by a network side are carried out, cell IDs which respective RRHs are in charge of have been changed (S15) according to the flowchart of FIG. 12. As a result of cell ID change at S15, the RRH #1 is changed from a cell ID=1 to a cell ID=2, the RRH #2 is changed from a cell ID=2 to a cell ID=3, and the RRH #3 is changed from a cell ID=3 to a cell ID=1 (S16-1, S16-2, S16-3).

As a result, an RRH that receives an access signal (S13) which a terminal transmits to a cell ID=1 is changed from the RRH #1 to the RRH #3. At least on the stage of cell search, the sync signal sent from the RRH #1 can be received with the largest receiving power. However, since the RRH that controls the cell ID is located at a position farther than the position where the RRH is located at the time of the cell search. Therefore, (a) there is a possibility that the access signal may not reach the network, and this poses a problem in that the terminal cannot begin data communication. (b) Assuming that the access signal reaches the network, if a cell shape further varies at the time of Grant transmission, Grant may not reach the terminal, and this poses a problem in that the terminal cannot begin data communication. Further, (c) a ramping activity is performed so that the access signal can raise the transmitting power thereof. If the cell shape further varies during the ramping, there arises a problem of power control that a connection is established with an initial terminal transmitting power higher than a power estimated by the network side.

As mentioned as S21 in FIG. 14, even when the position of a terminal is not fluctuated, the network side dynamically changes a cell configuration. Therefore, foreseeably, receiving powers measured by the terminal in relation to each cell ID may change, and a handoff may occur frequently.

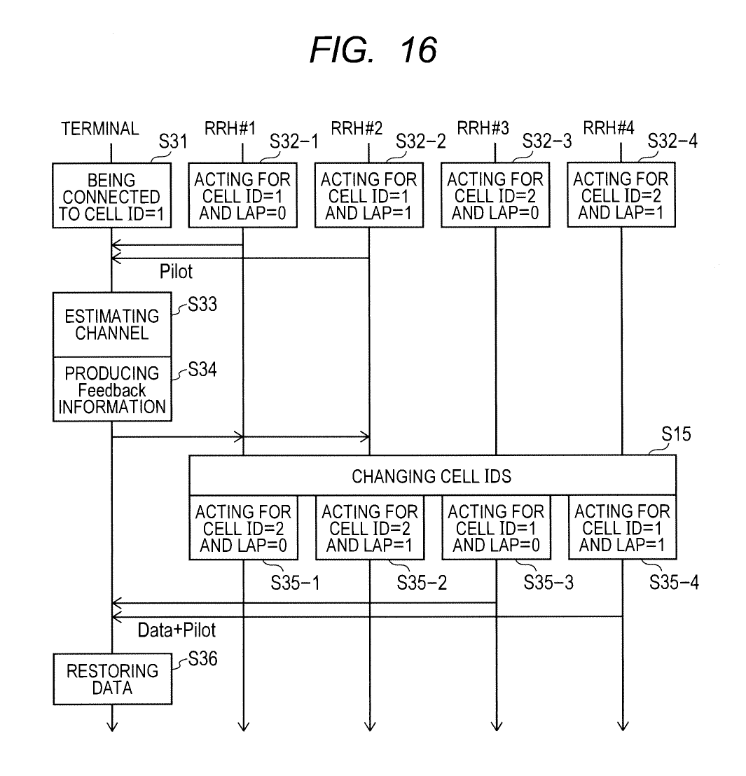

FIG. 16 is a sequence diagram for data communication in a case where a configuration of cells is changed in the distributed antenna system of the embodiment 1. A description will be made, especially, of a case where a CQI or any other data that is needed to be fed back is communicated.

An initial state in FIG. 16 is a state in which: a terminal is being communicated in a cell of a cell ID=1; and RRHs are transmitting or receiving signals of cell IDs and logical antenna ports (LAPS) shown in the drawing.

A terminal acts on the assumption that the terminal communicates data using one or plural logical antenna ports of a cell ID of a cell a connection to which has been established. Therefore, pilot signals sent through the logical antenna ports of the connected cell ID are referenced in order to perform propagation path estimation. Determination of a CQI and RI or selection of a PMI are performed and fed back to the network side. Based on the fed back CQI or the like, the network side communicates data to or from the terminal. Even during the data communication, the pilot signals are used to estimate a propagation path fluctuation a data signal has undergone, and detection or separation of multiple layers is carried out.

Since a terminal is connected to a cell of a cell ID=1, pilot signals sent through the logical antenna ports of the cell ID are used to perform propagation path estimation so as to determine a CQI, RI, or PMI prior to data communication (S33). Similarly to the system described in the non-patent literature 1 or 2, information such as the CQI, RI, or PMI to be fed back to the network side is produced (S34). If the cell ID is changed from one to another until the terminal begins data communication after performing feedback (S15), an RRH that communicates data to or from the terminal is changed from the one designated during feedback. As a result, a propagation path fluctuation which signals sent through the logical antenna ports undergo varies largely. There is a high possibility that the preliminarily estimated CQI, RI, or PMI may not an optimal solution any longer. As a result, a throughput capable of being provided for the terminal is degraded. The degradation of the throughput takes place even when the logical antenna ports rather than the cell ID are changed.

Although a throughput is degraded, even when a cell is dynamically changed, data communication itself succeeds. Since the pilots and data items outputted through the logical antenna ports are outputted from the same RRHs, the pilots and data items undergo the same propagation path fluctuation. A demodulation function such as detection acts properly.

Therefore, the embodiment 2 provides a distributed antenna system intended to prevent frequent occurrence of a handoff shown in FIG. 14, a state shown in FIG. 15 in which a handoff occurs during an initial access, and a state shown in FIG. 16 in which a throughput is degraded during data communication.

In the embodiment 2, RRHs, a cell ID, and logical antenna ports which are desirable for a terminal to be adapted to a wireless communication system in which a communication area to be dynamically allocated to the terminal varies are allocated. More particularly, cell IDs of an entire distributed antenna system are integrated into one, and the logical antenna ports are allocated on a fixed basis. Owing to this method, the aforesaid problems of an initial access, a handoff, a mismatch of feedback information such as a CQI are solved.

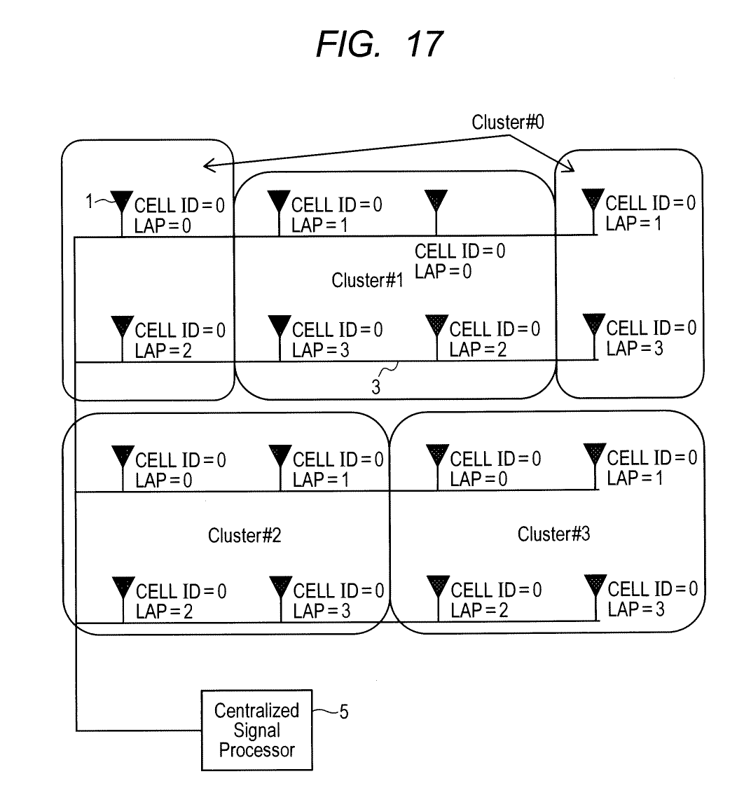

FIG. 17 shows an overall configuration of a distributed antenna system in the embodiment 2. In FIG. 17, one distributed antenna system configures a common cell. In this case, when a specific frequency is noted, the number of terminals capable of communicating simultaneously in a cell of a certain cell ID is limited to the number of logical antenna ports at maximum. Even when numerous RRHs are disposed, a throughput to be provided for each terminal is degraded due to the restriction on the number of simultaneously communicating terminals.

In order to prevent degradation of a throughput, an area of one cell ID is, as shown in FIG. 17, divided into plural clusters in order to provide communication areas. For example, like cluster #0, a cluster itself may be spatially and geographically separated into portions.

Since clusters perform data communication independently of one another, the number of simultaneously communicating terminals in the distributed antenna system proportional to the number of RRHs can be ensured. However, what is communicated independently in each cluster includes a data channel (for example, a physical downlink shared channel (PDSCH) or physical uplink shared channel (PUSCH)) and a control channel for controlling an individual data channel (a physical dedicated control channel (PDCCH)). The other channels and signals are treated in common among clusters.

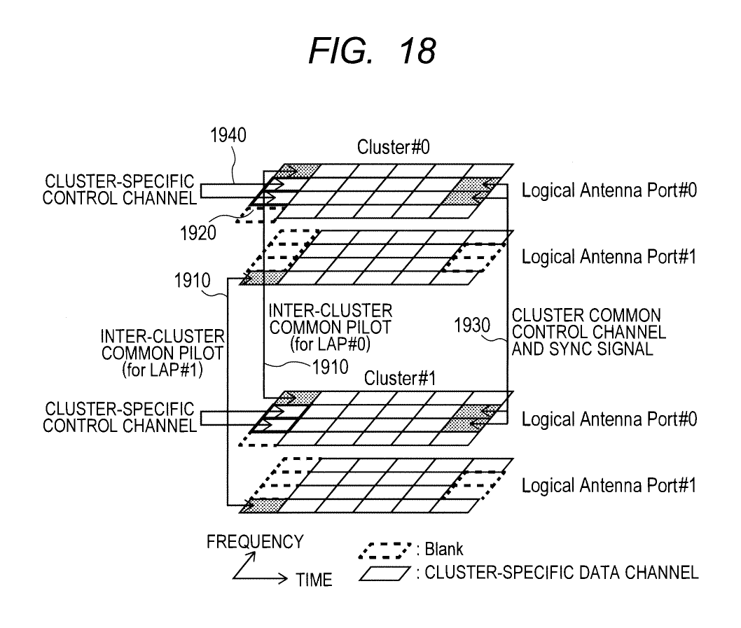

FIG. 18 shows an allocation method for various channels to a temporal frequency resource in units of a cluster and a logical antenna port. A case where each cluster is configured with two logical antenna ports LAP#0 and LAP#1 will be taken for instance. Channel allocation itself is carried out by the layer map module 302 in the centralized signal processing device 5.

On a data channel, data specific to each cluster is disposed. To what terminal a communication resource in a cluster is allocated is determined by the downlink packet scheduler 406 or uplink packet scheduler 407 in the cell multiple access device 9 (FIG. 8).

A pilot signal for each logical antenna port has the same pilot symbol 1910 disposed therein at the same temporal frequency among clusters. A temporal frequency resource at which a pilot symbol is disposed through a certain logical antenna port is treated as a blank resource 1920 through any other logical antenna port.

A control channel or sync signal 1930 to be used in common among clusters has the same symbol disposed thereon or therein at the same temporal frequency through a logical antenna port #0 in all clusters. More particularly, a broadcast channel to be transmitted to all terminals belonging to the distributed antenna system, and a sync signal are concerned. A control channel 1940 specific to a cluster has control information specific to each cluster disposed thereon. The drawing is depicted on the assumption that the control channel and sync signal are transmitted through the logical antenna port #0 as the simplest example. Alternatively, transmission diversity using plural logical antenna ports may be implemented.

When the transmission method for various channels and a signal shown in FIG. 18 is conformed, what undergoes the same propagation path as a pilot signal does includes only an inter-cluster common control channel and sync signal which are, similarly to the pilot, use in common among clusters. A cluster-specific data channel or control channel undergoes a different propagation path. Specifically, signals of the same cell ID and logical antenna port are outputted from plural RRHs, a result of propagation path estimation using pilot signals cannot specify from what RRHs the signals are transmitted. However, if there is a difference between the distances to RRHs that communicate data through the same logical antenna ports in different clusters with respect to a terminal, a pilot and a cluster-specific data channel are thought to undergo nearly the same propagation path because a propagation loss is large on a path from the terminal to the farther RRH.

By the way, if the distance difference is nearly null, the logical antenna port should preferably not be used by the terminal. An example of RRH preference list production processing to be performed by the RRH comparison unit 203 included in the route control device 7 in the second embodiment shown in FIG. 5 will be described below.

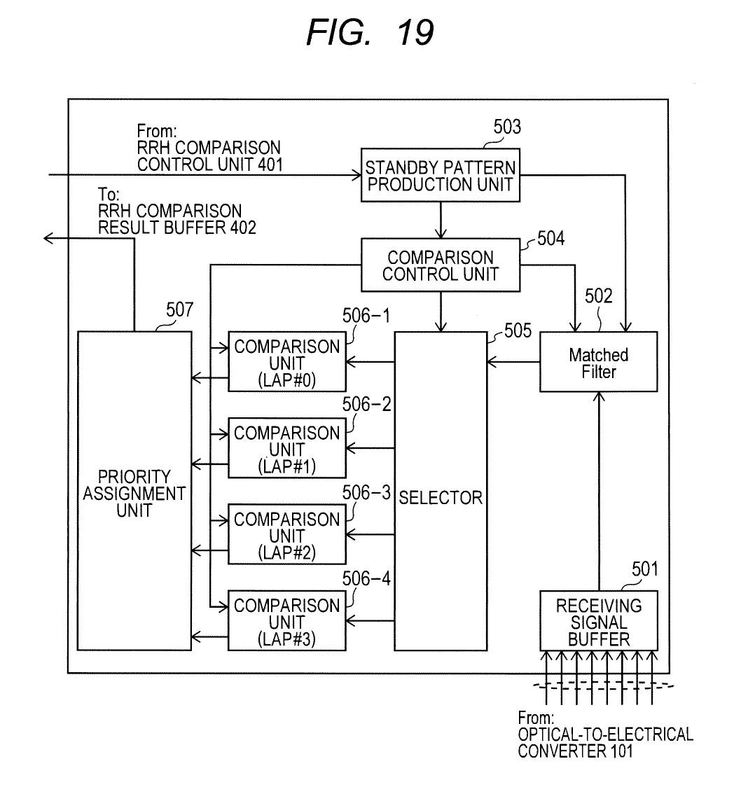

FIG. 19 shows an example of the RRH comparison unit 203 in the second embodiment. Transmitting signals sent from a terminal and received by respective RRHs are recorded as baseband digital IQ sampling signals in a receiving signal buffer 501 in association with the RRHs. A matched filer 502 performs correlation arithmetic on the IQ sampling signal stored in the receiving signal buffer 501 and a standby pattern produced by a standby pattern production unit 503, and outputs a result of the correlation arithmetic. To what RRH a receiving signal on which the correlation arithmetic is performed is related is posted by a comparison control unit 504. The receiving signal is read from the receiving signal buffer 501 with an address, at which the receiving signal relevant to the RRH is stored, as a leading address.

The standby pattern production unit 503 produces a standby pattern, which is to be set in the matched filter 502, on the basis of a terminal ID posted from the RRH comparison control unit (RRH comparison controller) 401 and information necessary to produce the standby pattern during correlation arithmetic, such as, a sub-frame number. In addition, a reset trigger is transmitted to the comparison control unit 504, and the comparison control unit 504 initializes an RRH counter to be controlled by the comparison control unit 504.

The comparison control unit 504 is a sequencer for performing correlation arithmetic sequentially on all RRHs. An RRH processing counter is initialized with a reset trigger outputted from the standby pattern production unit 503. Every time when the matched filter 502 outputs a correlation value, the processing counter is incremented in order to sequentially handle other RRHs. Comparison units 506 that are output destinations of a selector 505 implement control so that a logical antenna port allocated to the RRH on a fixed basis can be selected. After handling all the RRHs is completed, an enabler for outputting a value to each of the comparison units 506 is issued.

The selector 505 is a module that switches output destinations so that a result of output of the matched filter 502 can be inputted to the comparison unit 506 relevant to a logical antenna port allocated to an RRH on a fixed basis. A switching method is instructed by the comparison control unit 504.

The comparison units 506 are included in association with the logical antenna ports. Which of RRHs is most proper to a terminal for each logical antenna port is outputted to a priority assignment unit 507. In addition, when plural RRHs are proper to nearly the same degree, if the aforesaid problem (a cluster-specific data channel or control channel undergo a different propagation path) is predicted to occur, No Proper RRH is outputted to the priority assignment unit 507.

The comparison units 506 record a maximum value of a correlation value and the second largest value thereof, and individual identification numbers of RRHs relevant to which the two values are recorded. After correlation arithmetic processing on all RRHs is completed, when an enabler of value output is issued from the comparison control unit 504, a decision is made on whether the maximum value of the correlation value and the individual identification number of the RRH relevant to which the maximum value is recorded are posted, or a correlation value 0 is outputted in order to signify that there is no RRH individual identification number that should be outputted. The decision is made at the time when the enabler is issued. More particularly, the decision is made according to whether a ratio of the maximum value of the correlation value to the second largest value or a difference between the maximum value and second largest value exceeds a threshold value. If the ratio or difference exceeds the threshold value, a decision is made that the RRH relevant to which the maximum value of the correlation value is recorded is proper. The maximum value of the correlation value and the individual identification number of the RRH relevant to which the maximum value is recorded are outputted to the priority assignment unit 507. If the ratio or difference does not exceed the threshold value, it is decided that plural RRHs are nearly equidistant from a terminal with respect to the same logical antenna port. 0 is outputted as a correlation value to the priority assignment unit 507, and an arbitrary value (the RRH individual identification value relevant to the maximum value of the correlation value will do) is outputted as an RRH individual identification number.

The priority assignment unit 507 inputs an individual identification number of an RRH, which is most proper for each logical antenna port, and a correlation value. Except an RRH individual identification number relating to a correlation value 0, RRH individual identification numbers are prioritized orderly from the one associated with a logical antenna port of a high correlation value in such a manner as the first preference, second preference, etc. The RRH individual identification numbers are written in a list (FIG. 9) in the RRH comparison result buffer (RRH preference list buffer) 402 in descending order of priority. The RRH individual identification number relating to the correlation value 0 is not written.

According to the foregoing procedure, when plural RRHs are nearly equidistant with respect to a certain logical antenna port, the use of the logical antenna port may be ceased. As a result, the aforesaid second problem, that is, the problem that a cluster-specific data channel or control channel undergoes a different propagation path from a pilot signal does can be solved.

The second embodiment has been described so far.

According to the foregoing embodiment, for example, formation of plural communication areas in one distributed antenna system can be realized, and a SINR during communication of each terminal can be improved.

For example, even when only one cell can be configured within a distributed antenna system, since the number of simultaneously communicating terminals decreases, degradation of a throughput each terminal can enjoy can be prevented.

For example, when the number of simultaneously communicating terminals is increased, a throughput each terminal enjoys can be improved, and the place dependency of the throughput each terminal enjoys can be suppressed.

When terminals are used in the same cell ID within a distributed antenna system, and logical antenna port numbers connectable to wireless front end units are allocated on a fixed basis, an error between a signal processing method to be determined at the time of wireless propagation path estimation and a signal processing method optimal at the time of data communication is diminished. As a result, for example, a throughput a terminal enjoys can be improved.

When a cell-specific data channel, a cell-specific control channel, and an inter-cell common control channel are separately defined, and a neighbor list is contained in the inter-cell common control channel, at least one of an advantage that the number of simultaneously communicating terminals in a distributed antenna system can be ensured and an advantage that complication of handoff processing can be prevented can be provided.

### LIST OF REFERENCE SIGNS

1: antenna, 2: terminal, 3: optical fiber, 4: cell, 5: centralized signal processing device, 6: logical antenna port (LAP), 7: route control device, 8: remote radio head (RRH), 9: cell multiple access control device, 10: base station, 11: gateway, 101: optical-to-electrical converter, 102: digital-to-analog converter, 108: electrical-to-optical converter, 201: mask unit, 202: summation unit, 203: RRH comparison unit, 301: encoding and modulation module, 302: layer map module, 303: IFFT module, 304: FFT module, 305: layer detection module, 306: demodulation and decoding module, 307: user/control data buffer, 308: MAC control unit, 309: cell individual signal processing unit, 311: report production unit, 401: RRH comparison result buffer, 403: cell candidate buffer, 404: user grouping unit, 405: cell selection unit, 502: matched filter, 503: standby pattern production unit, 504: comparison control unit, 505: selector, 506: comparison unit, 507: priority assignment unit

1. A distributed antenna system comprising:
a plurality of wireless front end units that communicates with a terminal;
a route control device connected to the wireless front end units;
a signal processing control device connected to the route control device; and
a multiple access control device connected to the signal processing control device and route control device, wherein the distributed antenna system is characterized in that
the signal processing control device includes a plurality of communication area signal processing units that performs signal processing concerning a communication area to be provided for the terminal;
the multiple access control device posts a plurality of associations of the communication area signal processing units with the wireless front end units, which configure communication areas, to the route control device; and
based on the associations, the route control device controls signal processing between the wireless front end units and the signal processing control device.

2. The distributed antenna system as set forth in claim 1, characterized in that:
the association is information representing the relationship of connection between at least one logical antenna port provided by the communication area signal processing unit and the wireless front end unit; and
the multiple access control device determines a communication area to be allocated to a terminal, and instructs the signal processing control device to communicate with the terminal allocated to the communication area signal processing unit associated with the determined communication area.

3. The distributed antenna system as set forth in claim 1, characterized in that:
the route control device includes a comparison unit that measures a receiving power of an uplink signal, which is sent from a terminal, for each of the wireless front end units, and compares the receiving powers with one another among the wireless front end units; and
based on a result of the comparison, the multiple access control device configures a communication area using one or more wireless front end units.

4. The distributed antenna system as set forth in claim 1, characterized in that the signal processing control device is provided with a medium access control (MAC) control module including: a report generator that posts measurement information on a wireless propagation path, which is used to determine a communicating terminal for each communication area, to the multiple access control device; an uplink signal processing controller that posts a method of receiving in a formed communication area an uplink signal sent from a terminal, which is determined by the multiple access control device, to the communication area signal processing unit; a downlink signal processing controller that posts a method of transmitting in the formed communication area a downlink signal to the terminal, which is determined by the multiple access control device, to the communication area signal processing unit; and a downlink control information generator that produces downlink control information based on which the terminal that is a transmission destination of the downlink signal recognizes the downlink signal transmission method.

5. The distributed antenna system as set forth in claim 1, characterized in that the multiple access control device is provided with: a communication area candidate buffer in which a plurality of combinations of communication areas is recorded; a user grouping unit that groups to which of the communication areas of which of the combinations of communication areas each terminal belongs; a communication area selection unit that selects which of the combinations is used to configure communication areas at each time instant; and an uplink packet scheduler and downlink packet scheduler that perform packet scheduling in uplink or downlink communication in each of the communication areas determined by the communication area selection unit.

6. The distributed antenna system as set forth in claim 5, characterized in that:
the route control device includes a comparison unit that measures a receiving power of an uplink signal, which is sent from a terminal, for each of the wireless front end units, and compares the receiving powers with one another among the wireless front end units; and
the user grouping unit groups to which of the communication areas of which of the combinations each terminal belongs through comparative evaluation between a result of the comparison that is an output of the comparison unit and the communication area candidate buffer, and posts the combination to the signal processing control device.

7. The distributed antenna system as set forth in claim 3, characterized in that the route control device switches the communication area signal processing units to which the wireless front end units are connected through the same logical antenna port, and all pieces of communication area signal processing are performed based on the same identification information.

8. The distributed antenna system as set forth in claim 6, characterized in that the comparison unit compares the receiving powers with one another among the wireless front end units connected to the same logical antenna port.

9. The distributed antenna system as set forth in claim 8, characterized in that when a difference or ratio of the receiving powers between the wireless front ends connected to the same logical antenna port is recognized as being smaller than a threshold value, and the receiving powers are recognized as being nearly equal to one another among the plurality of wireless front end units, the comparison unit implements control for fear the logical antenna port should be used to communicate with the terminal.

10. The distributed antenna system as set forth in claim 6, characterized in that the signal processing control device performs control signal processing specific to each communication area, control signal processing that is common among the communication areas, and data signal processing specific to each communication area.

11. The distributed antenna system as set forth in claim 10, characterized in that different communication areas are configured in relation to at least two logical antenna ports.

12. A wireless communication method in a distributed antenna system including a plurality of wireless front end units, characterized in that:
based on the communicating states between the wireless front end units and a terminal, a plurality of communication areas formed with the wireless front end units is provided, and a plurality of terminals simultaneously communicates at the same temporal frequency in any one of the communication areas.

13. The wireless communication method as set forth in claim 12, characterized in that:
the communicating states are compared with one another among the front end units on the basis of the receiving powers of an uplink signal sent from a terminal; and
based on a result of the comparison, the wireless front end unit is specified for each terminal.

14. The wireless communication method as set forth in claim 12, characterized in that:
a plurality of combinations of communication areas is preserved, and one of the plurality of combinations is selected at a certain time instant in order to form a plurality of communication areas at the same time instant.

15. The wireless communication method as set forth in claim 12, characterized in that:
a communication area-specific data channel and a communication area-specific control channel are used to realize simultaneous communication of the plurality of terminals in a plurality of communication areas; and
an inter-communication area common control channel forms one communication area within an entire distributed antenna system.

16. The wireless communication method as set forth in claim 15, characterized in that:
the inter-communication area common control channel further contains a sync signal which the terminal uses to perform cell search or timing synchronization, and a reference signal to be used to estimate a fluctuation of a wireless propagation path.
